(19) United States
(12) Patent Application Publication
(10) Pub. No.: US 2026/0081658 A1
(43) Pub. Date: Mar. 19, 2026

(54) METHODS AND APPARATUS OF CODEBOOK ENHANCEMENT FOR COHERENT JOINT TRANSMISSION

(71) Applicant: LENOVO (BEIJING) LIMITED, Beijing (CN)

(72) Inventors: Yi ZHANG, Beijing (CN); Chenxi ZHU, Fairfax, VA (US); Wei LING, Beijing (CN); Bingchao LIU, Beijing (CN); Lingling XIAO, Beijing (CN)

(21) Appl. No.: 18/844,575

(22) PCT Filed: Apr. 29, 2022
(86) PCT No.: PCT/CN2022/090255

§ 371 Date: Sep. 6, 2024

(51) Int. Cl. H04B 7/06

(52) U.S. Cl. CPC H04B 7/0626; H04B 7/0632; H04B 7/0639

(57) ABSTRACT

Methods and apparatus of codebook enhancement for coherent joint transmission are disclosed. The apparatus includes: a receiver that receives a configuration signalling for a first codebook and a second codebook, wherein the first codebook is for Channel State Information (CSI) reporting to a first transmitting-receiving entity, and the second codebook is for CSI reporting to a second transmitting-receiving entity; a processor that determines a Precoder Matrix Indicator (PMI) based on the second codebook comprising one or more phase adjustment coefficients; and a transmitter that transmits the PMI in reporting of CSI.

### FIELD

The subject matter disclosed herein relates generally to wireless communication and more particularly relates to, but not limited to, methods and apparatus of codebook enhancement for coherent joint transmission.

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX), Transmit or Transmitter (TX), Code-Division Multiplexing (CDM), Channel State Information (CSI), Channel State Information Reference Signal (CSI-RS), Demodulation Reference Signal (DMRS), Frequency Division Duplex (FDD), Frequency Division Multiple Access (FDMA), Index/Identifier (ID), Multiple Input Multiple Output (MIMO), Phase-shift keying (PSK), Reference Signal (RS), Time-Division Duplexing (TDD), Transmission and Reception Point (TRP), Channel Quality Indicator (CQI), Discrete Fourier Transform (DFT), Frequency Range 1 (FR1), Frequency Range 2 (FR2), Precoder Matrix Indicator (PMI), Rank Indicator (RI), Transmission Configuration Indication (TCI), Technical Specification (TS), Joint Transmission (JT), Non-Coherent Joint Transmission (NC-JT), Coherent Joint Transmission (CJT).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHz) is called FR2. The 5G NR supports both FR1 and FR2 frequency bands.

Enhancements on multi-TRP/panel transmission including improved reliability and robustness with both ideal and non-ideal backhaul between these TRPs (Transmit Receive Points) are studied. A TRP is an apparatus to transmit and receive signals, and is controlled by a gNB through the backhaul between the gNB and the TRP.

It is important to identify and specify necessary enhancements for both downlink and uplink MIMO for facilitating the use of large antenna array, not only for FR1 but also for FR2 to fulfil the request for evolution of NR deployments in Release 18.

In 3GPP specification Release 16 and Release 17, features for facilitating multi-TRP deployments have been introduced, focusing on non-coherent joint transmission (NC-JT).

As coherent joint transmission (CJT) improves coverage and average throughput in commercial deployments with high-performance backhaul and synchronization, enhancement on CSI acquisition for FDD and TDD, targeting FR1, may be beneficial in expanding the utility of multi-TRP deployments.

### SUMMARY

Methods and apparatus of codebook enhancement for coherent joint transmission are disclosed.

According to a first aspect, there is provided an apparatus, including: a receiver that receives a configuration signalling for a first codebook and a second codebook, wherein the first codebook is for Channel State Information (CSI) reporting to a first transmitting-receiving entity, and the second codebook is for CSI reporting to a second transmitting-receiving entity; a processor that determines a Precoder Matrix Indicator (PMI) based on the second codebook comprising one or more phase adjustment coefficients; and a transmitter that transmits the PMI in reporting of CSI.

According to a second aspect, there is provided an apparatus, including: a transmitter that transmits a configuration signalling for a first codebook and a second codebook, wherein the first codebook is for Channel State Information (CSI) reporting to a first transmitting-receiving entity, and the second codebook is for CSI reporting to a second transmitting-receiving entity; a receiver that receives a Precoder Matrix Indicator (PMI), wherein the PMI is determined based on the second codebook comprising one or more phase adjustment coefficients.

According to a third aspect, there is provided a method, including: receiving, by a receiver, a configuration signalling for a first codebook and a second codebook, wherein the first codebook is for Channel State Information (CSI) reporting to a first transmitting-receiving entity, and the second codebook is for CSI reporting to a second transmitting-receiving entity; determining, by a processor, a Precoder Matrix Indicator (PMI) based on the second codebook comprising one or more phase adjustment coefficients; and transmitting, by a transmitter, the PMI in reporting of CSI.

According to a fourth aspect, there is provided a method, including: transmitting, by a transmitter, a configuration signalling for a first codebook and a second codebook, wherein the first codebook is for Channel State Information (CSI) reporting to a first transmitting-receiving entity, and the second codebook is for CSI reporting to a second transmitting-receiving entity; receiving, by a receiver, a Precoder Matrix Indicator (PMI), wherein the PMI is determined based on the second codebook comprising one or more phase adjustment coefficients.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4 is a schematic diagram illustrating an example of coherent joint transmission with multiple TRPs in accordance with some implementations of the present disclosure.

FIG. 5 is a flow chart illustrating steps of codebook enhancement for coherent joint transmission by UE in accordance with some implementations of the present disclosure; and

FIG. 6 is a flow chart illustrating steps of codebook enhancement for coherent joint transmission by gNB in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more”, and similarly items expressed in plural form also include reference to one or multiple instances of the item, unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

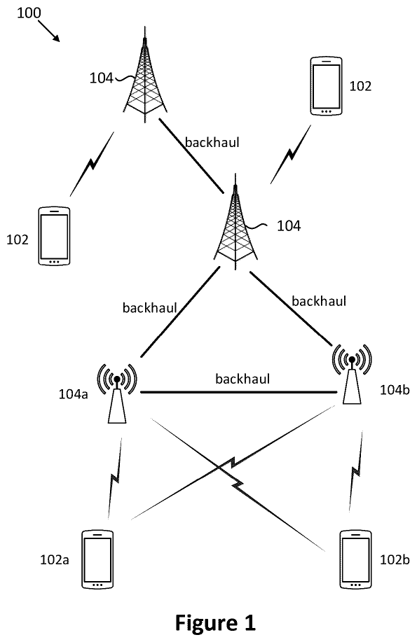

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal or ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP” and “transmitting-receiving identity” may be used interchangeably throughout the disclosure.

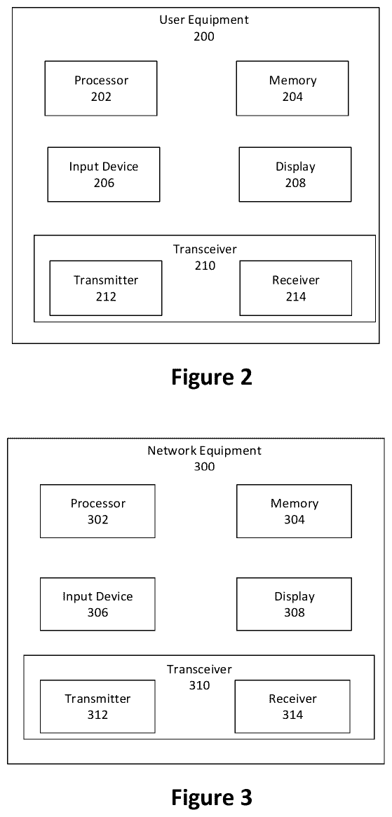

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

Release 16 and Release 17 type 2 codebook, including eType2 codebook in Release 16, eType2 port selection codebook in Release 16, and feType2 port selection codebook in Release 17, are designed based on single TRP transmission.

In Release 18, coherent joint transmission will be further studied, where same information may be transmitted coherently from multiple TRPs. To improve performance of coherent transmission, the CSI difference between TRPs may be useful. Several different schemes are proposed, with different trade-off between feedback overhead and system performance.

The e-Type2 codebook in Release 16 is described as follows, extracted from the section 5.2.2.2.5 of TS 38.214. Similar description for e-Type2 port selection codebook in Release 16 based on beamformed CSI-RS and fe-Type2 port selection codebook in Release 17 may be referred to in section 5.2.2.2.6 and 5.2.2.2.7 of TS 38.214.

For 4 antenna ports {3000, 3001, . . . , 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and UE configured with higher layer parameter codebookType set to ‘typeII-r16’
The values of N₁ and N₂ are configured with the higher layer parameter n1-n2-codebookSubsetRestriction-r16. The supported configurations of (N₁, N₂) for a given number of CSI-RS ports and the corresponding values of (O₁,O₂) are given in Table 5.2.2.2.1-2. The number of CSI-RS ports, P_{CSI-RS}, iS 2N₁N₂.
The values of L, β and pᵥ are determined by the higher layer parameter paramCombination-r16, where the mapping is given in Table 5.2.2.2.5-1.
   The UE is not expected to be configured with paramCombination-r16 equal to
      3, 4, 5, 6, 7, or 8 when P_{CSI-RS}=4,
      7 or 8 when P_{CSI-RS}<32
      7 or 8 when higher layer parameter typeII-RI-Restriction-r16 is configured with rᵢ=1 for any i>1.
      7 or 8 when R=2.

TABLE 5.2.2.2.5-1
Codebook parameter configurations for L, β and p_{υ}

| | |
|---|---|
| paramCombination- | p_{υ} |

| r16 | L | υ ∈ {1, 2} | υ ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

The UE shall report the RI value v according to the configured higher layer parameter typeII-RI-Restriction-r16. The UE shall not report v>4.
   The PMI value corresponds to the codebook indices of i₁ and i₂ where

$$\begin{matrix}{i}_{1} = \{ \begin{matrix}[ {i}_{1 , 1} {i}_{1 , 2} {i}_{1 , 5} {i}_{1 , 6 , 1} {i}_{1 , 7 , 1} {i}_{1 , 8 , 1} ] \\ [ {i}_{1 , 1} {i}_{1 , 2} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} ] \\ [ {i}_{1 , 1} {i}_{1 , 2} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} {i}_{1 , 6 , 3} {i}_{1 , 7 , 3} {i}_{1 , 8 , 3} ] \\ [ {i}_{1 , 1} {i}_{1 , 2} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} {i}_{1 , 6 , 3} {i}_{1 , 7 , 3} {i}_{1 , 8 , 3} {i}_{1 , 6 , 4} {i}_{1 , 7 , 4} {i}_{1 , 8 , 4} ]\end{matrix} & \begin{matrix}v = 1 \\ v = 2 \\ v = 3 \\ v = 4\end{matrix} \\ {i}_{1} = \{ \begin{matrix}[ {i}_{2 , 3 , 1} {i}_{2 , 4 , 1} {i}_{2 , 5 , 1} ] \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} ] \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} {i}_{2 , 3 , 3} {i}_{2 , 4 , 3} {i}_{2 , 5 , 3} ] \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} {i}_{2 , 3 , 3} {i}_{2 , 4 , 3} {i}_{2 , 5 , 3} {i}_{2 , 3 , 4} {i}_{2 , 4 , 4} {i}_{2 , 5 , 4} ]\end{matrix} & \begin{matrix}v = 1 \\ v = 2 \\ v = 3 \\ v = 4\end{matrix}\end{matrix}$$

The precoding matrices indicated by the PMI are determined from L+Mᵥ vectors.
L vectors,

$${v}_{{m}_{1}^{( i )} , {m}_{2}^{( i )}} , i = 0 , 1 , … , L - 1 ,$$

are identified by the indices q₁, q₂, n₁, n₂, indicated by i_{1,1}, i_{1,2}, obtained as in 5.2.2.2.3, where the values of C(x, y) are given in Table 5.2.2.2.5-4.

$${M}_{v} = ⌈ {p}_{v} \frac{{N}_{3}}{R} ⌉ vectors , {[ {y}_{0 , l}^{( f )} , {y}_{1 , l}^{( f )} , … , {y}_{{N}_{3} - 1 , l}^{( f )} ]}^{T} , f = 0 , 1 , … , {M}_{v} - 1 ,$$

are identified by Mᵢₙᵢₜᵢₐₗ (for N₃>19) and n_{3,l} (l=1, . . . , v) where

$$\begin{matrix}{M}_{initiαl} ∈ \{ - 2 {M}_{v} + 1 , - 2 {M}_{v} + 2 , … , 0 \} \\ {n}_{3 , l} = [ {n}_{3 , l}^{( 0 )} , … , {n}_{3 , l}^{( {M}_{v} - 1 )} ] \\ {n}_{3 , l}^{( f )} ∈ \{ 0 , 1 , … , {N}_{3} - 1 \}\end{matrix}$$

which are indicated by means of the indices i_{1,5} (for N₃>19) and i_{1,6,l} (for Mᵥ>1 and l=1, . . . , v),

$$\begin{matrix}{i}_{1 , 5} ∈ \{ 0 , 1 , … , 2 {M}_{v} - 1 \} \\ {i}_{1 , 6 , l} ∈ \{ \begin{matrix}\{ 0 , 1 , … , ( \begin{matrix}{N}_{3} - 1 \\ {M}_{v} - 1\end{matrix} ) - 1 \} & {N}_{3} \leq 19 \\ \{ 0 , 1 , … , ( \begin{matrix}2 {M}_{v} - 1 \\ {M}_{v} - 1\end{matrix} ) - 1 \} & {N}_{3} > 19\end{matrix}\end{matrix}$$

The amplitude coefficient indicators i_{2,3,l} and i_{2,4,l} are

$$\begin{matrix}{i}_{2 , 3 , l} = [ {k}_{l , 0}^{( 1 )} {k}_{l , 1}^{( 1 )} ] \\ {i}_{2 , 4 , l} = [ {k}_{l , 0}^{( 2 )} … {k}_{l , {M}_{v} - 1}^{( 2 )} ] \\ {k}_{l , f}^{( 2 )} = [ {k}_{l , 0 , f}^{( 2 )} … {k}_{l , 2 L - 1 , f}^{( 2 )} ] \\ {k}_{l , p}^{( 1 )} ∈ \{ 1 , … , 15 \} \\ {k}_{l , i , f}^{( 2 )} ∈ \{ 0 , … , 7 \}\end{matrix}$$

for l=1, . . . , v.
The phase coefficient indicator i_{2,5,l} is

$$\begin{matrix}{i}_{2 , 5 , l} = [ {c}_{l , 0} … {c}_{l , {M}_{v} - 1} ] \\ {c}_{l , f} = [ {c}_{l , 0 , f} … {c}_{l , 2 L - 1 , f} ] \\ {c}_{l , i , f} ∈ \{ 0 , … , 15 \}\end{matrix}$$

for l=1, . . . , v.
Let K₀=┌β2LM₁┐. The bitmap whose nonzero bits identify which coefficients in i_{2,4,i} and i_{2,5,l} are reported, is indicated by i_{1,7,l}

$$\begin{matrix}{i}_{1 , 7 , l} = [ {k}_{l , 0}^{( 3 )} … {k}_{l , {M}_{v} - 1}^{( 3 )} ] \\ {k}_{l , f}^{( 3 )} = [ {k}_{l , 0 , f}^{( 3 )} … {k}_{l , 2 , L - 1 , f}^{( 3 )} ] \\ {k}_{l , i , f}^{( 3 )} ∈ \{ 0 , 1 \}\end{matrix}$$

for l=1, . . . , v, such that

$${K}_{l}^{N Z} = {Σ}_{i = 0}^{2 L - 1} {Σ}_{f = 0}^{{M}_{v} - 1} {k}_{l , i , f}^{( 3 )} \leq {K}_{0}$$

is the number of nonzero coefficients for layer l=1, . . . , v and

$${K}^{N Z} = {Σ}_{l = 1}^{v} {K}_{l}^{N Z} \leq 2 {K}_{0}$$

is the total number of nonzero coefficients.
The indices of i_{2,4,l}, i_{2,5,l} and i_{1,7,l} are associated to the My codebook indices in n_{3,l}.
The mapping from

$${k}_{l , p}^{( 1 )}$$

to the amplitude coefficient

$${p}_{l , p}^{( 1 )}$$

is given in Table 5.2.2.2.5-2 and the mapping from

$${k}_{l , i , f}^{( 2 )}$$

to the amplitude coefficient

$${p}_{l , i , f}^{( 2 )}$$

is give in Table 5.2.2.2.5-3. The amplitude coefficients are represented by

$${p}_{l}^{( 1 )} = [ \begin{matrix}{p}_{l , 0}^{( 1 )} & {p}_{l , 1}^{( 1 )}\end{matrix} ]$$

$${p}_{l}^{( 2 )} = [ {p}_{l , 0}^{( 2 )} … {p}_{l , {M}_{v} - 1}^{( 2 )} ]$$

$${p}_{l , f}^{( 2 )} = [ {p}_{l , 0 , f}^{( 2 )} … {p}_{l , 2 L - 1 , f}^{( 2 )} ]$$

for l=1, . . . , v.

### Let

$${f}_{l}^{*} ∈ \{ 0 , 1 , … , {M}_{v} - 1 \}$$

be the index of i_{2,4,l} and iₗ*∈{0,1, . . . , 2L−1} be the index of

$${k}_{l , {f}_{l}^{*}}^{( 2 )}$$

which identify the strongest coefficient of layer l, i.e., the element

$${k}_{l , {i}_{l}^{*} , {f}_{l}^{*}}^{( 2 )}$$

of i_{2,4,l}, for l=1, . . . , v. The codebook indices of n_{3,l} are remapped with respect to

$${n}_{3 , l}^{( {f}_{l}^{*} )}$$

as

$${n}_{3 , l}^{( f )} = ( {n}_{3 , l}^{( f )} - {n}_{3 , l}^{( {f}_{l}^{*} )} )$$

mod N₃, such that

$${n}_{3 , l}^{( {f}_{l}^{*} )} = 0 ,$$

after remapping. The index f is remapped with respect to

$${f}_{l}^{*} as f = ( f - {f}_{l}^{*} )$$

mod Mᵥ, such that the index of the strongest coefficient is

$${f}_{l}^{*} = 0 ( l = 1 , … , v ) ,$$

after remapping. The indices of i_{2,4,l}, i_{2,5,l} and i_{1,7,l} indicate amplitude coefficients, phase coefficients and bitmap after remapping.
The strongest coefficient of layer l is identified by i_{1,8,l}∈{0,1, . . . , 2L−1}, which is obtained as follows

$${i}_{1 , 8 , l} = \{ \begin{matrix}{\sum }_{i = 0}^{{i}_{1}^{*}} {k}_{1 , i , 0}^{( 3 )} - 1 & v = 1 \\ {i}_{l}^{*} & 1 < v \leq 4\end{matrix}$$

$$for l = 1 , … , v .$$

TABLE 5.2.2.2.5-2
$Mapping of elements of {i}_{2 , 3 , l} : {k}_{l , p}^{( 1 )} to {p}_{l , p}^{( 1 )}$

| ${k}_{l , p}^{( 1 )}$ | ${p}_{l , p}^{( 1 )}$ |
|---|---|
| 0 | Reserved |
| 1 | $\frac{1}{\sqrt{128}}$ |
| 2 | ${( \frac{1}{8192} )}^{1 / 4}$ |
| 3 | $\frac{1}{8}$ |
| 4 | ${( \frac{1}{2048} )}^{1 / 4}$ |
| 5 | $\frac{1}{2 \sqrt{8}}$ |
| 6 | ${( \frac{1}{512} )}^{1 / 4}$ |
| 7 | $\frac{1}{4}$ |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | $\frac{1}{2}$ |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

The amplitude and phase coefficient indicators are reported as follows:

$${k}_{l , ⌊ \frac{{i}_{l}^{*}}{L} ⌋}^{( 1 )} = 15 , {k}_{l , {i}_{l}^{*} , 0}^{( 2 )} = 7 , {k}_{l , {i}_{l}^{*} , 0}^{( 3 )} = 1 and {c}_{l , {i}_{l}^{*} , 0} = 0 ( l = 1 , … , v ) .$$

The indicators

$${k}_{l , ⌊ \frac{{i}_{l}^{*}}{L} ⌋}^{( 1 )} , {k}_{l , {i}_{l}^{*} , 0}^{( 2 )} and {c}_{l , {i}_{l}^{*} , 0}$$

are not reported for l=1, . . . , v.
The indicator

$${k}_{l , ( ⌊ \frac{{i}_{l}^{*}}{L} ⌋ + 1 ) mod 2}^{( 1 )}$$

is reported for l=1, . . . , v.
The K^{NZ}-v indicators

$${k}_{l , i , f}^{( 2 )}$$

for which

$${k}_{l , i , f}^{( 3 )} = 1 , i \neq {i}_{l}^{*} ,$$

f≠0 are reported.
The K^{NZ}-v indicators c_{1,i,f} for which

$${k}_{l , i , f}^{( 3 )} = 1 , i \neq {i}_{l}^{*} ,$$

f≠0 are reported.
The remaining 2L·Mᵥ·v−K^{NZ} indicators

$${k}_{l , i , f}^{( 2 )}$$

are not reported.
The remaining 2L·Mᵥ·v−K^{NZ} indicators c_{1,i,f} are not reported.

TABLE 5.2.2.2.5-3
$Mapping of elements of {i}_{2 , 4 , l} : {k}_{l , i , f}^{( 2 )} to {p}_{l , i , f}^{( 2 )}$

| ${k}_{l , i , f}^{( 2 )}$ | ${p}_{l , i , f}^{( 2 )}$ |
|---|---|
| 0 | $\frac{1}{8 \sqrt{2}}$ |
| 1 | $\frac{1}{8}$ |
| 2 | $\frac{1}{4 \sqrt{2}}$ |
| 3 | $\frac{1}{4}$ |
| 4 | $\frac{1}{2 \sqrt{2}}$ |
| 5 | $\frac{1}{2}$ |
| 6 | $\frac{1}{\sqrt{2}}$ |
| 7 | 1 |

The elements of n₁ and n₂ are found from i_{1,2} using the algorithm described in 5.2.2.2.3, where the values of C(x, y) are given in Table 5.2.2.2.5-4.
When n_{3,l} and Mᵢₙᵢₜᵢₐₗ are known, i_{1,5} and i_{1,6,l} (l=1, . . . , v) are found as follows:
If N₃≤19, i_{1,5}=0 and is not reported. If Mᵥ=1, i_{1,6,l}=0, for l=1, . . . , v, and is not reported. If Mᵥ>1,

$${i}_{1 , 6 , l} = {\sum }_{f = 1}^{{M}_{v} - 1} C ( {N}_{3} - 1 - {n}_{3 , l}^{( f )} , {M}_{v} - f ) ,$$

where C(x, y) is given in Table 5.2.2.2.5-4 and where the indices f=1, . . . , Mᵥ−1 are assigned such that

$${n}_{3 , l}^{( f )}$$

cases as f increases.
If N₃>19, Mᵢₙᵢₜᵢₐₗ is indicated by i_{1,5}, which is reported and given by

$${i}_{1 , 5} = \{ \begin{matrix}{M}_{initial} & {M}_{initial} = 0 \\ {M}_{initial} + 2 {M}_{v} & {M}_{initial} < 0\end{matrix}$$

Only the nonzero indices

$${n}_{3 , l}^{( f )}$$

∈Ints={(Mᵢₙᵢₜᵢₐₗ+i) mod N₃, i=0, 1, . . . , 2Mᵥ−1}, are reported, where the indices f=1, . . . , Mᵥ−1 are assigned such that

$${n}_{3 , l}^{( f )}$$

increases as f

$${n}_{l}^{( f )} = \{ \begin{matrix}{n}_{3 , l}^{( f )} & {n}_{3 , l}^{( f )} \leq {M}_{initial} + 2 {M}_{v} - 1 \\ {n}_{3 , l}^{( f )} - ( {N}_{3} - 2 {M}_{v} ) & {n}_{3 , l}^{( f )} > {M}_{initial} + {N}_{3} - 1\end{matrix} ,$$

$$then {i}_{1 , 6 , l} = {\sum }_{f = 1}^{{M}_{v} - 1} C ( 2 {M}_{v} - 1 - {n}_{l}^{( f )} , {M}_{v} - f ) ,$$

where C(x, y) is given in Table 5.2.2.2.5-4.
The codebooks for 1-4 layers are given in Table 5.2.2.2.5-5, where

$${m}_{1}^{( i )} , {m}_{2}^{( i )} , for i = 0 , 1 , … , L - 1 , {v}_{{m}_{1}^{( i )} , {m}_{2}^{( i )}}$$

are obtained as in clause 5.2.2.2.3, and the quantities φ_{l,i,f} and y_{t,l} are given by

$${φ}_{l , i , f} = {e}^{j \frac{2 π {c}_{l , i , f}}{16}}$$

$${y}_{t , l} = [ \begin{matrix}{y}_{t , l}^{( 0 )} & {y}_{t , l}^{( 1 )} & ⋯ & {y}_{t , l}^{( {M}_{v} - 1 )}\end{matrix} ]$$

where t={0, 1, . . . , N₃−1}, is the index associated with the precoding matrix, l={1, . . . , v}, and with

$${y}_{t , l}^{( f )} = {e}^{j \frac{2 π {tn}_{3 , l}^{( f )}}{{N}_{3}}}$$

for f=0, 1, . . . , Mᵥ−1.

TABLE 5.2.2.2.5-5
Codebook for 1-layer. 2-layer, 3-layer and 4-layer CSI reporting using antenna ports 3000 to 2999 + P_{CSI-RS}

| Layers | |
|---|---|
| υ = 1 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{( 1 )} = {W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1}$ |
| υ = 2 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , t}^{( 2 )} = \frac{1}{\sqrt{2}} [ \begin{matrix}{W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} & {W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2}\end{matrix} ]$ |
| υ = 3 | $\begin{matrix}{W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , t}^{( 3 )} = \\ \frac{1}{\sqrt{3}} [ \begin{matrix}{W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} & {W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2} & {W}_{{q}_{1} , {q}_{2} , {n}_{1} , {n}_{2} , {n}_{3 , 3} , {p}_{3}^{( 1 )} , {p}_{3}^{( 2 )} , {i}_{2 , 5 , 3} , t}^{3}\end{matrix} ]\end{matrix}$ |
| υ = 4 | $\begin{matrix}{W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , {n}_{3 , 4} , {p}_{4}^{( 1 )} , {p}_{4}^{( 2 )} , {i}_{2 , 5 , 4} , t}^{( 4 )} = \\ \frac{1}{2} [ \begin{matrix}{W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} & {W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2} & {W}_{{q}_{1} , {q}_{2} , {n}_{1} , {n}_{2} , {n}_{3 , 3} , {p}_{3}^{( 1 )} , {p}_{3}^{( 2 )} , {i}_{2 , 5 , 3} , t}^{3} & {W}_{{q}_{1} , {q}_{2} , {n}_{1} , {n}_{2} , {n}_{3 , 4} , {p}_{4}^{( 1 )} , {p}_{4}^{( 2 )} , {i}_{2 , 5 , 4} , t}^{4}\end{matrix} ]\end{matrix}$ |

$Where {W}_{{q}_{1} , {q}_{2} , {n}_{1} , {n}_{2} , {n}_{3 , l} , {p}_{l}^{( 1 )} , {p}_{l}^{( 2 )} , {i}_{2 , 5 , l} , t}^{l} = \frac{1}{\sqrt{{N}_{1} {N}_{2} {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{υ} - 1} {y}_{t , l}^{( f )} {p}_{l , i , f}^{( 2 )} {φ}_{l , i , f} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{υ} - 1} {y}_{t , l}^{( f )} {p}_{l , i + L , f}^{( 2 )} {φ}_{l , i + L , f}\end{matrix} ] , l = 1 , 2 , 3 , 4 , {γ}_{t , l} =$
${\sum }_{i = 0}^{2 L - 1} {( {p}_{l , ⌊ \frac{i}{L} ⌋}^{( 1 )} )}^{2} {\vert {\sum }_{f = 0}^{{M}_{υ} - 1} {y}_{t , l}^{( f )} {p}_{l , i , f}^{( 2 )} {φ}_{l , i , f} \vert}^{2} and the mappings from {i}_{1} to {q}_{1} , {q}_{2} , {n}_{1} , {n}_{2} , {n}_{3 , 1} , {n}_{3 , 2} , {n}_{3 , 3} , {n}_{3 , 4} , and from {i}_{2} to {i}_{2 , 5 , 1} , {i}_{2 , 5 , 2} , {i}_{2 , 5 , 3} , {i}_{2 , 5 , 4} ,$
${p}_{1}^{( 1 )} , {p}_{2}^{( 1 )} , {p}_{3}^{( 1 )} and {p}_{4}^{( 1 )} , {p}_{1}^{( 2 )} , {p}_{2}^{( 2 )} , {p}_{3}^{( 2 )} and {p}_{4}^{( 2 )} are as described above , including the ranges of the constituent indices of {i}_{1} and {i}_{2} .$

For coefficients with

$${k}_{l , i , f}^{( 3 )} = 0 ,$$

amplitude and phase are set to zero, i.e.,

$${p}_{l , i , f}^{( 2 )} = 0$$

and φ_{l,i,f}=0.

The e-Type2 codebook in Release 16 is designed based on Type2 codebook defined in Release 15 with reducing feedback overhead using DFT transformation on account of limited number of multipath/taps. Similar design principle is also used for e-Type2 port selection codebook in Release 16 based on beamformed CSI-RS and fe-Type2 port selection codebook in Release 17 for FDD system with further exploiting reciprocity on angular and delay domain to reduce feedback overhead.

These designs in Release 16 and Release 17 are all based on single TRP transmission. The CSI difference between TRPs is not considered during feedback. However, it is important for coherent joint transmission to guarantee system performance.

In this disclosure, the enhancement on codebook design is proposed to capture CSI difference between TRPs based on current common codebook structure, i.e.,

$$P = {W}_{1} {W}_{2} {W}_{f}^{H} ,$$

for e-Type2 codebook, e-Type2 port selection codebook and fe-Type2 port selection codebook, where phase adjustment information may be carried on W₁, or W₂, or W_{f}, respectively.

With coherent joint transmission, the same information bits may be transmitted from multiple coordinated TRPs with precoding using the precoding matrix for each TRP.

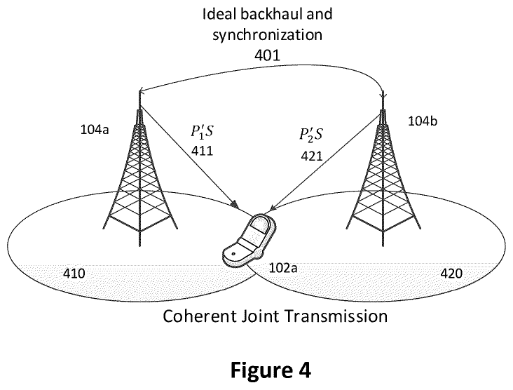

FIG. 4 is a schematic diagram illustrating an example of coherent joint transmission with multiple TRPs in accordance with some implementations of the present disclosure. In this example, the U E 102a is located at the edge of the coverage 410 of the first TRP 104a, and at the edge of the coverage 420 of the second TRP 104b. The UE may be in communication with TRP1 104a and TRP2 104b with communication links 411 and 421, respectively. The CSI feedback may be used for gNB to determine precoding matrix, which includes PMI for TRP1 (P₁), PMI for TRP2 (P₂), and phase adjustment information (which may also be called cophasing information, e^{jθ}) between TRP1 104a and TRP2 104b. P₁ and P₂ may be determined based on CSI between TRP 1 and UE and CSI between TRP2 and UE, respectively, according to existing enhanced Type2 codebook, including e-Type2 codebook in Release 16, e-Type2 port selection codebook in Release 16, and/or fe-Type2 port selection codebook in Release 17. For phase adjustment, it is assumed to be made on P₂ for TRP2 as it is made relative adjustment based on, or with respect to, P₁.

For existing codebook structure,

$$P = {W}_{1} {W}_{2} {W}_{f}^{H} ,$$

where W₁∈ [symbol] , W_{f}∈ [symbol] and W₂∈ [symbol] , P=2N₁N₂ denotes CSI-RS port number, L denotes selected beam number for composing refined beams, N₃ denotes subband PMI number, Mᵥ denotes number of basis vectors in the transform domain for layer v. The dimensions for W₁, W₂, W_{f}, may be determined based on gNB configuration with Table 5.2.2.2.5-1 of TS 38.214 as previously recited.

The details of component matrix are provided as follows:

$${W}_{1} = [ \begin{matrix}{v}_{0} {v}_{1} … {v}_{L - 1} & 0 \\ 0 & {v}_{0} {v}_{1} … {v}_{L - 1}\end{matrix} ]$$

for e-Type2 codebook, where

$${\{ {v}_{i} \}}_{i = 0}^{L - 1}$$

are N₁N₂×1 orthogonal DFT vectors and denote the selected beams; or

$${W}_{1} = [ \begin{matrix}Wa & 0 \\ 0 & W b\end{matrix} ] ,$$

where

$$Wa = {e}^{j {θ}_{0}} {e}_{mod ( md , \frac{X}{2} )}^{( \frac{X}{2} )} \qquad {e}^{j {θ}_{1}} {e}_{mod ( md + 1 , \frac{X}{2} )}^{( \frac{X}{2} )} \qquad … \qquad {e}^{j {θ}_{L - 1}} {e}_{mod ( md + L - 1 , \frac{X}{2} )}^{( \frac{X}{2} )} ,$$

$$and$$

$$W b = {e}^{j {θ}_{0}} {e}_{mod ( md , \frac{X}{2} )}^{( \frac{X}{2} )} \qquad {e}^{j {θ}_{1}} {e}_{mod ( md + 1 , \frac{X}{2} )}^{( \frac{X}{2} )} \qquad … \qquad {e}^{j {θ}_{L - 1}} {e}_{mod ( md + L - 1 , \frac{X}{2} )}^{( \frac{X}{2} )} ,$$

for e-Type2 port selection codebook or fe-Type2 port selection codebook, where

$${e}_{i}^{( \frac{X}{2} )}$$

is a length

$$- \frac{X}{2}$$

vector with i-th element equal to 1, and 0 elsewhere and denote the selected CSI-RS ports; X is CSI-RS port number, d is a configured parameter,

$$m ∈ \{ 0 , 1 , … , ⌈ \frac{X}{2 d} - 1 \} ;$$

the selected beams are carried by selected beamformed CSI-RS port;

$${W}_{f} = [ {f}_{{k}_{0}} {f}_{{k}_{1}} … {f}_{{k}_{{M}_{v} - 1}} ] , where {\{ {f}_{{k}_{m}} \}}_{m = 0}^{{M}_{ν} - 1}$$

are Mᵥ size N₃×1 orthogonal DFT vectors and it is used to transform the linear combination coefficients from frequency domain to transformation domain; and
W₂ is linear combination coefficient matrix and UE reports the quantization of the non-zero coefficients in W₂.

Regarding P₁ for TRP1, the existing e-Type2 codebook may be used for feedback and

$${P}_{1} = {P}_{1}^{′} .$$

To support coherent joint transmission between TRP1 and TRP2, three kinds of schemes are proposed for generation of an enhanced codebook with consideration of P₂ for TRP2 and cophasing information e^{jθ} relative to P₁. With the enhanced codebook, gNB may determine precoding matrix

$${P}_{2}^{′}$$

for coherent joint transmission.

To simplify the coherent transmission, the configuration parameters for W₁, W₂ need to be the same, to guarantee same dimensions for W₁, W₂, and W_{f} between P₁ and P₂, and the configuration parameters include CSI-RS port number (i.e., 2N₁N₂ is CSI-RS port number) and corresponding N₁, N₂, selected beam number L, frequency compression ratio pᵥ, and subband PMI number per subband CQI numberOfPMI-SubbandsPerCQI-Subband. The codebook parameter can be configured by one common signalling or two separate signalings for one codebook for PMI1 and another codebook for PMI2. For separate codebook parameter configuration signalling, the same values may be configured for some parameters in the two codebooks, including CSI-RS port number (i.e., 2N₁N₂ is CSI-RS port number) and corresponding N₁, N₂, selected beam number L, frequency compression ratio pᵥ, and subband PMI number per subband CQI numberOfPMI-SubbandsPerCQI-Subband.

### W₁ Based Enhanced Codebook Design

In this kind of schemes, phase adjustment is made on beam level.

In detail, for legacy e-Type2 codebook,

$${P}_{2} = {W}_{1} {W}_{2} {W}_{f}^{H}$$

where

$${W}_{1} = [ \begin{matrix}{v}_{0} {v}_{1} … {v}_{L - 1} & 0 \\ 0 & {v}_{0} {v}_{1} … {v}_{L - 1}\end{matrix} ] ;$$

and for enhanced codebook,

$${P}_{2}^{′} = {\tilde{W}}_{1} {W}_{2} {W}_{f}^{H}$$

and enhancement is made on W₁ based on P₂, where

$${\tilde{W}}_{1} = [ \begin{matrix}{e}^{j {θ}_{0}} {v}_{0} & {e}^{j {θ}_{1}} {v}_{1} … {e}^{j {θ}_{L - 1}} {v}_{L - 1} & & 0 \\ & 0 & {e}^{j {θ}_{0}} {v}_{0} & {e}^{j {θ}_{1}} {v}_{1} … {e}^{j {θ}_{L - 1}} {v}_{L - 1}\end{matrix} ]$$

for enhanced e-Type2 codebook; or

$${\tilde{W}}_{1} = [ \begin{matrix}Wa & 0 \\ 0 & Wb\end{matrix} ] , where$$

$$Wa = \begin{matrix}{e}^{j {θ}_{0}} {e}_{mod ( md , \frac{X}{2} )}^{( \frac{X}{2} )} & {e}^{j {θ}_{1}} {e}_{mod ( md + 1 , \frac{X}{2} )}^{( \frac{X}{2} )} & … & {e}^{j {θ}_{L - 1}} {e}_{mod ( md + L - 1 , \frac{X}{2} )}^{( \frac{X}{2} )}\end{matrix} ,$$

$$and$$

$$Wb = \begin{matrix}{e}^{j {θ}_{0}} {e}_{mod ( md , \frac{X}{2} )}^{( \frac{X}{2} )} & {e}^{j {θ}_{1}} {e}_{mod ( md + 1 , \frac{X}{2} )}^{( \frac{X}{2} )} & … & {e}^{j {θ}_{L - 1}} {e}_{mod ( md + L - 1 , \frac{X}{2} )}^{( \frac{X}{2} )}\end{matrix} ,$$

for enhanced e-Type2 port selection codebook and feType2 port selection codebook;

and

θ₀, . . . , θ_{L-1} are adjustment phases (i.e., phase adjustment coefficients) for L beam pairs with one beam of beam pair from one TRPs.

In some other examples,

$${\tilde{W}}_{1} = [ \begin{matrix}{e}^{j {θ}_{0}} {v}_{0} & {e}^{j {θ}_{1}} {v}_{1} … {e}^{j {θ}_{L - 1}} {v}_{L - 1} & & 0 \\ & 0 & {e}^{j {θ}_{0}} {v}_{0} & {e}^{j {θ}_{1}} {v}_{1} … {e}^{j {θ}_{L - 1}} {v}_{L - 1}\end{matrix} ]$$

for enhanced e-Type2 codebook; or

$${\tilde{W}}_{1} = [ \begin{matrix}Wa & 0 \\ 0 & Wb\end{matrix} ] , where$$

$$Wa = \begin{matrix}{e}^{j {θ}_{0}} {e}_{mod ( md , \frac{X}{2} )}^{( \frac{X}{2} )} & {e}^{j {θ}_{1}} {e}_{mod ( md + 1 , \frac{X}{2} )}^{( \frac{X}{2} )} & … & {e}^{j {θ}_{L - 1}} {e}_{mod ( md + L - 1 , \frac{X}{2} )}^{( \frac{X}{2} )}\end{matrix} ,$$

$$and$$

$$Wb = \begin{matrix}{e}^{j {θ}_{0}} {e}_{mod ( md , \frac{X}{2} )}^{( \frac{X}{2} )} & {e}^{j {θ}_{1}} {e}_{mod ( md + 1 , \frac{X}{2} )}^{( \frac{X}{2} )} & … & {e}^{j {θ}_{L - 1}} {e}_{mod ( md + L - 1 , \frac{X}{2} )}^{( \frac{X}{2} )}\end{matrix} ,$$

for enhanced e-Type2 port selection codebook and feType2 port selection codebook; and
θ_{0,0}, . . . , θ_{L-1,0}, . . . , θ_{0,1}, . . . , θ_{L-1,1} are phase adjustment coefficients for the selected beams or selected beamformed CSI-RS ports. θ_{0,0}, . . . , θ_{L-1,0} are phase adjustment coefficients for one polarization and θ_{0,1}, . . . , θ_{L-1,1} are phase adjustment coefficients for another polarization.

The candidate values for adjustment phase may be values from 4 PSK symbol set (i.e. e^{jθ}∈{1,j,−1,−j}) or 8 PSK symbol set (i.e. e^{jθ}_{∈}

$$\{ 1 , {e}^{j \frac{π}{4}} , j , {e}^{j \frac{3 π}{4}} , - 1 , {e}^{j \frac{5 π}{4}} , - j , {e}^{j \frac{7 π}{4}} \} ) .$$

In some other examples, the candidate values for adjustment phase may be values from 16 PSK symbol set.

With larger size of candidate value set, it may achieve better adjustment accuracy and thus better performance, but with higher overhead. From feedback view, additional new indicators i_{1,9,1,1}, . . . , i_{1,9,1,L} are introduced to indicate adjustment phase for L beam pairs on top of the existing i_{1,1}, i_{1,2} for beam selection indication, i_{1,8,1}, . . . , i_{1,8,v} for strongest efficient indication for each layer, i_{2,3,1}, . . . , i_{2,3,v} for amplitude coefficient indication for another polarization without strongest efficient, i_{1,5}, i_{1,6,1}, . . . , i_{1,6,v} for indicating selected basic vectors for transformation domain, {i_{2,4,l}}_{l=1, . . . , v} {i_{2,5,l}}_{l=1, . . . , v} for indicating amplitude and phase for non-zero coefficients in transform domain, {i_{1,7,l}}_{l=1, . . . , v} for indicating non-zero coefficient location in W₂ by bitmap. When phase adjustment is made per polarization, additional new indicators may be introduced to indicate adjustment phase for L beam pairs for both polarization, respectively.

For example, when L=4 selected beams are configured, 8 or 12 additional bits are used for indicating adjustment phase in the case where phase values from 4 or 8 PSK symbol set are used for quantization, respectively. The addition bits are doubled when phase adjustment is made per polarization.

For legacy e-Type2 codebook, selected beams {v₀, v₁, . . . v_{L-1}} are layer common. But W₂, W_{f} are layer specific based on the existing e-Type2 codebook design. To make further enhancement on performance, the phase adjustment between a pair of beams may also be layer specific. When the maximum rank is restricted to 2, the additional new indicators i_{1,9,2,1}, . . . , i_{1,9,2,L} are introduced on top of i_{1,9,1,1}, . . . , i_{1,9,1,L}. The feedback overhead will be doubled.

### W_{f} Based Enhanced Codebook Design

In this kind of schemes, phase adjustment is made on subband level.

In detail, for legacy e-Type2 codebook,

$${P}_{2} = {W}_{1} {W}_{2} {W}_{f}^{H}$$

where

$${W}_{f} = [ {f}_{{k}_{0}} {f}_{{k}_{1}} … {f}_{{k}_{{M}_{v} - 1}} ] and {W}_{f} ( i , k ) = {e}^{\frac{j 2 π ki}{{N}_{3}}} , i = 0 , 1 , … , {N}_{3} - 1 ;$$

for enhanced codebook,

$${P}_{2}^{′} = {W}_{1} {{W}_{2} ( {W}_{3} {W}_{f} )}^{H}$$

and enhancement is made on W_{f} based on P₂, where

$${W}_{3} = [ \begin{matrix}{e}^{j {θ}_{0}} & … & 0 \\ ⋮ & ⋱ & ⋮ \\ 0 & … & {e}^{j {θ}_{{N}_{3} - 1}}\end{matrix} ]$$

and
diagonal elements, θ₀, . . . , θ_{N}_{₃}₋₁, are adjustment phases (i.e., phase adjustment coefficients) between TRPs for N₃ subbands.

The candidate values for adjustment phase may be values from 4 PSK symbol set (i.e. e^{jθ}∈{1, j,−1,−j}) or 8 PSK symbol set (i.e. e^{jθ}∈

$$\{ 1 , {e}^{j \frac{π}{4}} , j , {e}^{j \frac{3 π}{4}} , - 1 , {e}^{j \frac{5 π}{4}} , - j , {e}^{j \frac{7 π}{4}} \} ) .$$

In some other examples, the candidate values for adjustment phase may be values from 16 PSK symbol set.

Since W₂, W_{f} are layer specific based on the existing e-Type2 codebook, the newly introduced adjustment phase may also be layer specific. From feedback view, additional new indicators i_{1,9,1,1}, . . . , i_{1,9,N}_{₃}_{,1}, . . . , i_{1,9,N}_{₃}_{,v} are introduced to indicate adjustment phase for each subband per layer.

For example, when there are 13 subbands according to configuration and rank 2 is reported, 52 or 78 additional bits are used for indicating phase adjustment in the case where adjustment phase values from 4 or 8 PSK symbol set are used for quantization, respectively.

Thus, this kind of schemes may have the largest overhead, but the best performance.

### W₂ Based Enhanced Codebook Design

In this kind of schemes, phase adjustment is made on the non-zero coefficients in the transformation domain.

For legacy e-Type2 codebook,

$${P}_{2} = {W}_{1} {W}_{2} {W}_{f}^{H}$$

where

$${W}_{2} = [ \begin{matrix}{\tilde{c}}_{0 , 0} & … & {\tilde{c}}_{0 , {M}_{v} - 1} \\ ⋮ & ⋱ & ⋮ \\ {\tilde{c}}_{2 L - 1 , 0} & … & {\tilde{c}}_{2 L - 1 , {M}_{v} - 1}\end{matrix} ]$$

and the non-zero coefficients in W₂ are reported.

The non-zero coefficient location in W₂ is indicated by {i_{1,7,l}}_{l=1 . . . , v} with bitmap for each layer l; amplitude and phase for non-zero coefficients in W₂ are indicated by {i_{2,4,l}}_{l=1, . . . , v} {i_{2,5,l}}_{l=1, . . . , v} for each layer l.

For enhanced codebook,

$${P}_{2}^{′} = {W}_{1} {\tilde{W}}_{2} {W}_{f}^{H}$$

and enhancement is made on W₂ based on P₂, where

$${\tilde{W}}_{2} = [ \begin{matrix}{e}^{j {θ}_{0 , 0}} {\tilde{c}}_{0 , 0} & … & {e}^{j {θ}_{0 , {M}_{v} - 1}} {\tilde{c}}_{0 , {M}_{v} - 1} \\ ⋮ & ⋱ & ⋮ \\ {e}^{j {θ}_{2 L - 1 , 0}} {\tilde{c}}_{2 L - 1 , 0} & … & {e}^{j {θ}_{2 L - 1 , {M}_{v} - 1}} {\tilde{c}}_{2 L - 1 , {M}_{v} - 1}\end{matrix} ] ;$$

\tilde{c}_{0,0}, . . . , \tilde{c}_{0,M}_{ᵥ}₋₁, . . . , \tilde{c}_{2L-1,M}_{ᵥ}₋₁ are the linear combination coefficients in W₂; and θ_{0,0}, . . . , θ_{0,M}_{ᵥ}₋₁, . . . , θ_{2L-1,M}_{ᵥ}₋₁ are adjustment phase for the joint basis between TRPs, where the joint basis refers to the basis including one basis for the selected beam and another basis for the selected basis in transform domain.

For zero value in W₂, it will remain zero in \tilde{W}₂ and there is no need to report adjustment phase.

Thus, the non-zero values for {θ_{0,0}, . . . , θ_{0,M}_{ᵥ}₋₁, . . . , θ_{2L-1,M}_{ᵥ}₋₁} may also be indicated by the same {i_{1,7,l}}_{l=1, . . . , v} as that for W₂. The additional indicator {i_{2,6,l}}_{l=1 . . . , v} can be used to indicate non-zero adjustment phase corresponding non-zero linear combination coefficients in W₂.

For example, when the maximum non-zero coefficient is set as 12 for maximum rank 2 based on codebook configuration parameters, 24 or 36 additional bits are used for indicating phase adjustment in the case where adjustment phase values from 4 or 8 PSK symbol set is used for quantization, respectively.

In this kind of schemes, the feedback overhead is relatively lower compared with subband level phase adjustment schemes since the phase adjustment is made in the transformation domain and the number of non-zero values for phase adjustment is reduced.

To further reduce feedback overhead, adjustment phase may be merged into the reporting of {i_{1,7,l}}_{l=1, . . . , v}, {i_{2,4,l}}_{l=1, . . . , v}, {i_{2,5,l}}_{l=1, . . . , v} for indicating non-zero coefficients in W₂. In principle, for non-zero values in W₂, the adjustment phase for each layer can be merged together as phasing reporting for c_{i,f}_{ᵥ} since the phase of non-zero linear combination coefficients in W₂ are reported by {i_{2,5,l}}_{l=1 . . . , v}.

Thus, the same {i_{1,7,l}}_{l=1 . . . , v} as that for W₂ may be reused for indicating the location of non-zero phase value for reporting of \tilde{W}₂. {i_{2,5,l}}_{l=1, . . . , v} may be updated with merging phase adjustment value into phase value for non-zero linear combination coefficients for W₂. For the strongest coefficients in W₂, the amplitude and phase are not reported (i.e., value for phase is set as ‘0’ and value for amplitude is set as ‘1’) according to the existing reporting scheme using eType2 codebook. Here, additional bits are needed for reporting of \tilde{W}₂ to indicate the phase adjustment between TRPs for the strongest coefficients. The adjustment phases for the strong coefficients need to be layer specific as strong coefficients are layer specific indicated in the existing e-Type2 codebook by {i_{1,8,l}}_{l=1, . . . , v}.

The candidate values for adjustment phase may be values from 16PSK symbol set since 16PSK symbol set is used for quantization of phase information for non-zero linear combination coefficients in W₂ and it is assumed that the same granularity is used for phase adjustment between TRPs and phase information for non-zero linear combination coefficients in W₂.

For example, only 8 additional bits are used for indicating adjustment phase for strongest coefficients in the case where adjustment phase values from 16 PSK symbol set are used for quantization and rank 2 is assumed. With the proposed feedback schemes with merging/updating the phase information, the feedback overhead is further reduced. Good trade-off between feedback overhead and system performance is achieved.

Although the enhanced codebook is made with phase adjustment between TRPs, it is also applicable for enhanced codebook with both phase and amplitude adjustment between TRPs.

In some examples, phase adjustment e^{jθ} is made on in W₁ or W₂ or W₃ as disclosed. In some other examples, both amplitude and phase adjustment factors, i.e. α×e^{jθ}, is made on in W₁ or W₂ or W₃, where a is amplitude adjustment value. The codebook enhanced schemes are similar to those schemes with phase adjustment but with additional amplitude adjustment. Additional signalling bits are needed for reporting the amplitude adjustment value.

For enhanced codebook on W₂, adjustment amplitude may be merged into amplitude of non-zero coefficients in W₂. The same {i_{1,7,l}}_{l=1, . . . , v} as that for W₂ may be reused for indicating the location of non-zero amplitude values for reporting of \tilde{W}₂. {i_{2,4,1}} 1=1 . . . , may be updated with merging amplitude adjustment value into amplitude value for non-zero linear combination coefficients for W₂.

For the strongest coefficients in W₂, the amplitude and phase are not reported (i.e., value for phase is set as ‘0’ and value for amplitude is set as ‘1’) according to the existing reporting scheme using eType2 codebook. Here, additional bits may be needed for reporting of \tilde{W}₂ to indicate the amplitude adjustment between TRPs for the strongest coefficients. The adjustment amplitude for the strong coefficients needs to be layer specific as strong coefficients are layer specific indicated in the existing e-Type2 codebook by {i_{1,8,l}}_{l=1, . . . , v}.

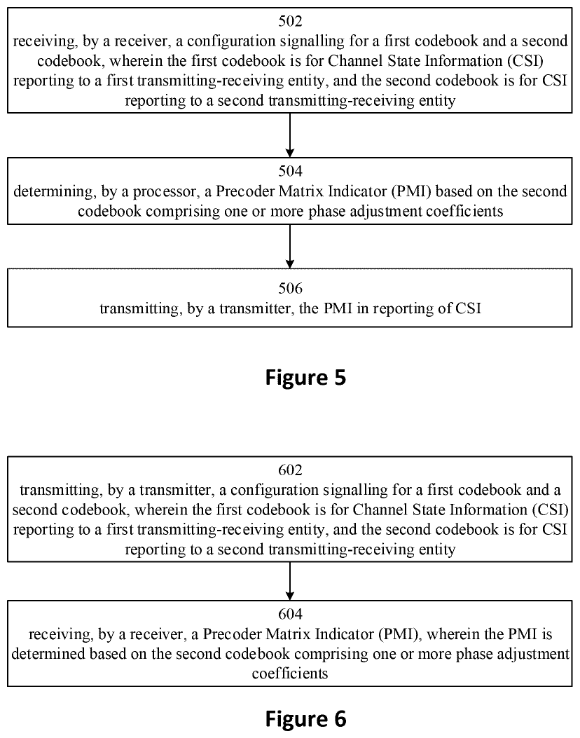

FIG. 5 is a flow chart illustrating steps of codebook enhancement for coherent joint transmission by UE 200 in accordance with some implementations of the present disclosure.

At step 502, the receiver 214 of UE 200 receives a configuration signalling for a first codebook and a second codebook, wherein the first codebook is for Channel State Information (CSI) reporting to a first transmitting-receiving entity, and the second codebook is for CSI reporting to a second transmitting-receiving entity.

At step 504, the processor 202 of UE 200 determines a Precoder Matrix Indicator (PMI) based on the second codebook comprising one or more phase adjustment coefficients.

At step 506, the transmitter 212 of UE 200 transmits the PMI in the reporting of CSI.

FIG. 6 is a flow chart illustrating steps of codebook enhancement for coherent joint transmission by gNB 300 in accordance with some implementations of the present disclosure.

At step 602, the transmitter 312 of gNB 300 transmits a configuration signalling for a first codebook and a second codebook, wherein the first codebook is for Channel State Information (CSI) reporting to a first transmitting-receiving entity, and the second codebook is for CSI reporting to a second transmitting-receiving entity.

At step 604, the receiver 314 of gNB 300 receives a Precoder Matrix Indicator (PMI), wherein the PMI is determined based on the second codebook comprising one or more phase adjustment coefficients.

In one aspect, some items as examples of the disclosure concerning UE may be summarized as follows:
1. An apparatus, comprising:
a receiver that receives a configuration signalling for a first codebook and a second codebook, wherein the first codebook is for Channel State Information (CSI) reporting to a first transmitting-receiving entity, and the second codebook is for CSI reporting to a second transmitting-receiving entity;
a processor that determines a Precoder Matrix Indicator (PMI) based on the second codebook comprising one or more phase adjustment coefficients; and
a transmitter that transmits the PMI in reporting of CSI.
2. The apparatus of item 1, wherein the second codebook is generated with phase adjustment coefficients for selected beams or beamformed CSI-RS ports.
3. The apparatus of item 2, wherein the PMI is determined based on

$$P = {\tilde{W}}_{1} {W}_{2} {W}_{f}^{H} , where$$

$${\tilde{W}}_{1} = [ \begin{matrix}{e}^{j {θ}_{0}} {v}_{0} & {e}^{j {θ}_{1}} {v}_{1} … {e}^{j {θ}_{L - 1}} {v}_{L - 1} & & 0 \\ & 0 & {e}^{j {θ}_{0}} {v}_{0} & {e}^{j {θ}_{1}} {v}_{1} … {e}^{j {θ}_{L - 1}} {v}_{L - 1}\end{matrix} ] ;$$

$${\{ {v}_{i} \}}_{i = 0}^{L - 1}$$

denotes the selected beams or selected beamformed CSI-RS ports; and θ_{0,0}, . . . , θ_{L-1,0}, . . . , θ_{0,1}, . . . , θ_{L-1,1} are phase adjustment coefficients for the selected beams or selected beamformed CSI-RS ports.
4. The apparatus of item 3, wherein the second codebook further comprises θ_{0,0}, . . . , θ_{L-1,0}, . . . , θ_{0,1}, . . . , θ_{L-1,1} from 4 or 8 or 16 Phase-Shift Keying (PSK) symbol set.
5. The apparatus of item 3, wherein each value of θ_{0,0}, . . . , θ_{L-1,0}, . . . , θ_{0,1}, . . . , θ_{L-1,1} is determined independently for each layer.
6. The apparatus of item 3 or 5, wherein each value of θ_{0,0}, . . . , θ_{L-1,0} and its corresponding value of θ_{0,1}, . . . , θ_{L-1,1} are determined to have a same value.
7. The apparatus of item 1, wherein the second codebook is generated with phase adjustment coefficients for each subband.
8. The apparatus of item 7, wherein the PMI is determined based on

$$P = {W}_{1} {{W}_{2} ( {W}_{3} {W}_{f} )}^{H} , where {W}_{3} = [ \begin{matrix}{e}^{j {θ}_{0}} & … & 0 \\ ⋮ & ⋱ & ⋮ \\ 0 & … & {e}^{j {θ}_{{N}_{3} - 1}}\end{matrix} ] ;$$

θ₀, . . . , θ_{N}_{₃}₋₁, are phase adjustment coefficients for N₃ subbands.
9. The apparatus of item 8, wherein the second codebook further comprises θ₀, . . . , θ_{N}_{₃}₋₁ from 4 or 8 or 16 PSK symbol set.
10. The apparatus of item 8, wherein each value of θ₀, . . . , θ_{N}_{₃}₋₁ is determined independently for each layer.
11. The apparatus of item 1, wherein the second codebook is generated with phase adjustment coefficients for linear combination coefficients.
12. The apparatus of item 11, wherein the PMI is determined based on

$$P = {W}_{1} {\tilde{W}}_{2} {W}_{f}^{H} where {\tilde{W}}_{2} = [ \begin{matrix}{e}^{j {θ}_{0 , 0}} {\tilde{c}}_{0 , 0} & … & {e}^{j {θ}_{0 , {M}_{v} - 1}} {\tilde{c}}_{0 , {M}_{v} - 1} \\ ⋮ & ⋱ & ⋮ \\ {e}^{j {θ}_{2 L - 1 , 0}} {\tilde{c}}_{2 L - 1 , 0} & … & {e}^{j {θ}_{2 L - 1 , {M}_{v} - 1}} {\tilde{c}}_{2 L - 1 , {M}_{v} - 1}\end{matrix} ] ;$$

\tilde{c}_{0,0}, . . . , \tilde{c}_{0,M}_{ᵥ}₋₁, . . . , \tilde{c}_{2L-1,M}_{ᵥ}₋₁ are the linear combination coefficients in W₂; and θ_{0,0}, . . . , θ_{0,M}_{ᵥ}₋₁, . . . , θ_{2L-1,M}_{ᵥ}₋₁ are phase adjustment coefficients for the linear combination coefficients.
13. The apparatus of item 12, wherein the second codebook further comprises θ_{0,0}, . . . , θ_{0,M}_{ᵥ}₋₁, . . . , θ_{2L-1,M}_{ᵥ}₋₁ from 4, 8, or 16 PSK symbol set.
14. The apparatus of item 12, wherein location of non-zero elements of θ_{0,0}, . . . , θ_{0,M}_{ᵥ}₋₁, . . . , θ_{2L-1,M}_{ᵥ}₋₁ in W₂ is indicated by a bitmap, and the bitmap is the same as that for non-zero linear combination coefficients of \tilde{c}_{0,0}, . . . , \tilde{c}_{0,M}_{ᵥ}₋₁, . . . , \tilde{c}_{2L-1,M}_{ᵥ}₋₁.
15. The apparatus of item 12, wherein each value of the non-zero elements of θ_{0,0}, . . . , θ_{0,M}_{ᵥ}₋₁, . . . , θ_{2L-1,M}_{ᵥ}₋₁ is determined independently for each layer.
16. The apparatus of item 12, wherein the second codebook comprises merged combination coefficients based on merge between non-zero elements of θ_{0,0}, . . . , θ_{0,M}_{ᵥ}₋₁, . . . , θ_{2L-1,M}_{ᵥ}₋₁ and phase of non-zero linear combination coefficients of \tilde{c}_{0,0}, . . . , \tilde{c}_{0,M}_{ᵥ}₋₁, . . . , \tilde{c}_{2L-1,M}_{ᵥ}₋₁.
17. The apparatus of item 16, wherein the second codebook further comprises feedback bits indicating the strongest merged combination coefficients of each layer.
18. The apparatus of item 1, wherein the first codebook and the second codebook are configured with common configuration parameters of:
CSI-RS port number and corresponding N₁ and N₂,
selected beam number L,
frequency compression ratio pᵥ, and
subband PMI number per subband Channel Quality Indicator (CQI).

In another aspect, some items as examples of the disclosure concerning gNB may be summarized as follows:
19. A n apparatus, comprising:
a transmitter that transmits a configuration signalling for a first codebook and a second codebook, wherein the first codebook is for Channel State Information (CSI) reporting to a first transmitting-receiving entity, and the second codebook is for CSI reporting to a second transmitting-receiving entity;
a receiver that receives a Precoder Matrix Indicator (PMI), wherein the PMI is determined based on the second codebook comprising one or more phase adjustment coefficients.
20. The apparatus of item 19, wherein the second codebook is generated with phase adjustment coefficients for selected beams or beamformed CSI-RS ports.
21. The apparatus of item 20, wherein the PMI is determined based on

$$P = {\tilde{W}}_{1} {W}_{2} {W}_{f}^{H} , where$$

$${\tilde{W}}_{1} = [ \begin{matrix}{e}^{j {θ}_{0 , 0}} {v}_{0} & {e}^{j {θ}_{1 , 0}} {v}_{1} … {e}^{j {θ}_{L - 1 , 0}} {v}_{L - 1} & & 0 \\ & 0 & {e}^{j {θ}_{0 , 1}} {v}_{0} & {e}^{j {θ}_{1 , 1}} {v}_{1} … {e}^{j {θ}_{L - 1 , 1}} {v}_{L - 1}\end{matrix} ] ;$$

$${\{ {v}_{i} \}}_{i = 0}^{L - 1}$$

denotes the selected beams or selected beamformed CSI-RS ports; and θ_{0,0}, . . . , θ_{L-1,0}, . . . , θ_{0,1}, . . . , θ_{L-1,1} are phase adjustment coefficients for the selected beams or selected beamformed CSI-RS ports.
22. The apparatus of item 21, wherein the second codebook further comprises θ_{0,0}, . . . , θ_{L-1,0}, . . . , θ_{0,1}, . . . , θ_{L-1,1} from 4 or 8 or 16 Phase-Shift Keying (PSK) symbol set.
23. The apparatus of item 21, wherein each value of θ_{0,0}, . . . , θ_{L-1,0}, . . . , θ_{0,1}, . . . , θ_{L-1,1} is determined independently for each layer.
24. The apparatus of item 21 or 23, wherein each value of θ_{0,0}, . . . , θ_{L-1,0} and its corresponding value of θ_{0,1}, . . . , θ_{L-1,1} are determined to have a same value.
25. The apparatus of item 19, wherein the second codebook is generated with phase adjustment coefficients for each subband.
26. The apparatus of item 25, wherein the PMI is determined based on

$$P = {W}_{1} {{W}_{2} ( {W}_{3} {W}_{f} )}^{H} , where {W}_{3} = [ \begin{matrix}{e}^{j {θ}_{0}} & … & 0 \\ ⋮ & ⋱ & ⋮ \\ 0 & … & {e}^{j {θ}_{{N}_{3} - 1}}\end{matrix} ] ;$$

θ₀, . . . , θ_{N}_{₃}₋₁, are phase adjustment coefficients for N₃ subbands.
27. The apparatus of item 26, wherein the second codebook further comprises θ₀, . . . , θ_{N}_{₃}₋₁ from 4 or 8 or 16 PSK symbol set.
28. The apparatus of item 26, wherein each value of θ₀, . . . , θ_{N}_{₂}₋₁ is determined independently for each layer.
29. The apparatus of item 19, wherein the second codebook is generated with phase adjustment coefficients for linear combination coefficients.
30. The apparatus of item 29, wherein the PMI is determined based on

$$P = {W}_{1} {\tilde{W}}_{2} {W}_{f}^{H} where {\tilde{W}}_{2} = [ \begin{matrix}{e}^{j {θ}_{0 , 0}} {\tilde{c}}_{0 , 0} & … & {e}^{j {θ}_{0 , {M}_{v} - 1}} {\tilde{c}}_{0 , {M}_{v} - 1} \\ ⋮ & ⋱ & ⋮ \\ {e}^{j {θ}_{2 L - 1 , 0}} {\tilde{c}}_{2 L - 1 , 0} & … & {e}^{j {θ}_{2 L - 1 , {M}_{v} - 1}} {\tilde{c}}_{2 L - 1 , {M}_{v} - 1}\end{matrix} ] ;$$

\tilde{c}_{0,0}, . . . , \tilde{c}_{0,M}_{ᵥ}₋₁, . . . , \tilde{c}_{2L-1,M}_{ᵥ}₋₁ are the linear combination coefficients in W₂; and θ_{0,0}, . . . , θ_{0,M}_{ᵥ}₋₁, . . . , θ_{2L-1,M}_{ᵥ}₋₁ are phase adjustment coefficients for the linear combination coefficients.
31. The apparatus of item 30, wherein the second codebook further comprises θ_{0,0}, . . . , θ_{0,M}_{ᵥ}₋₁, . . . , θ_{2L-1,M}_{ᵥ}₋₁ from 4, 8, or 16 PSK symbol set.
32. The apparatus of item 30, wherein location of non-zero elements of θ_{0,0}, . . . , θ_{0,M}_{ᵥ}₋₁, . . . , θ_{2L-1,M}_{ᵥ}₋₁ in W₂ is indicated by a bitmap, and the bitmap is the same as that for non-zero linear combination coefficients of \tilde{c}_{0,0}, . . . , \tilde{c}_{0,M}_{ᵥ}₋₁, . . . , \tilde{c}_{2L-1,M}_{ᵥ}₋₁.
33. The apparatus of item 30, wherein each value of the non-zero elements of θ_{0,0}, . . . , θ_{0,M}_{ᵥ}₋₁, . . . , θ_{2L-1,M}_{ᵥ}₋₁ is determined independently for each layer.
34. The apparatus of item 30, wherein the second codebook comprises merged combination coefficients based on merge between non-zero elements of θ_{0,0}, . . . , θ_{0,M}_{ᵥ}₋₁, . . . , θ_{2L-1,M}_{ᵥ}₋₁ and phase of non-zero linear combination coefficients of \tilde{c}_{0,0}, . . . , \tilde{c}_{0,M}_{ᵥ}₋₁, . . . , \tilde{c}_{2L-1,M}_{ᵥ}₋₁.
35. The apparatus of item 34, wherein the second codebook further comprises feedback bits indicating the strongest merged combination coefficients of each layer.
36. The apparatus of item 19, wherein the first codebook and the second codebook are configured with common configuration parameters of:
CSI-RS port number and corresponding N₁ and N₂,
selected beam number L,
frequency compression ratio pᵥ, and
subband PMI number per subband Channel Quality Indicator (CQI).

In a further aspect, some items as examples of the disclosure concerning a method of UE may be summarized as follows:
37. A method, comprising:
receiving, by a receiver, a configuration signalling for a first codebook and a second codebook, wherein the first codebook is for Channel State Information (CSI) reporting to a first transmitting-receiving entity, and the second codebook is for CSI reporting to a second transmitting-receiving entity;
determining, by a processor, a Precoder Matrix Indicator (PMI) based on the second codebook comprising one or more phase adjustment coefficients; and
transmitting, by a transmitter, the PMI in reporting of CSI.
38. The method of item 37, wherein the second codebook is generated with phase adjustment coefficients for selected beams or beamformed CSI-RS ports.
39. The method of item 38, wherein the PMI is determined based on

$$P = {\tilde{W}}_{1} {W}_{2} {W}_{f}^{H} , where$$

$${\tilde{W}}_{1} = [ \begin{matrix}{e}^{j {θ}_{0 , 0}} {v}_{0} & {e}^{j {θ}_{1 , 0}} {v}_{1} … {e}^{j {θ}_{L - 1 , 0}} {v}_{L - 1} & & 0 \\ & 0 & {e}^{j {θ}_{0 , 1}} {v}_{0} & {e}^{j {θ}_{1 , 1}} {v}_{1} … {e}^{j {θ}_{L - 1 , 1}} {v}_{L - 1}\end{matrix} ] ;$$

$${\{ {v}_{i} \}}_{i = 0}^{L - 1}$$

denotes the selected beams or selected beamformed CSI-RS ports; and θ_{0,0}, . . . , θ_{L-1,0}, . . . , θ_{0,1}, . . . , θ_{L-1,1} are phase adjustment coefficients for the selected beams or selected beamformed CSI-RS ports.
40. The method of item 39, wherein the second codebook further comprises θ_{0,0}, . . . , θ_{L-1,0}, . . . , θ_{0,1}, . . . , θ_{L-1,1} from 4 or 8 or 16 Phase-Shift Keying (PSK) symbol set
41. The method of item 39, wherein each value of θ_{0,0}, . . . , θ_{L-1,0}, . . . , θ_{0,1}, . . . , θ_{L-1,1} is determined independently for each layer.
42. The method of item 39 or 41, wherein each value of θ_{0,0}, . . . , θ_{L-1,0} and its corresponding value of θ_{0,1}, . . . , θ_{L-1,1} are determined to have a same value.
43. The method of item 37, wherein the second codebook is generated with phase adjustment coefficients for each subband.
44. The method of item 43, wherein the PMI is determined based on

$$P = {W}_{1} {{W}_{2} ( {W}_{3} {W}_{f} )}^{H} , where {W}_{3} = [ \begin{matrix}{e}^{j {θ}_{0}} & … & 0 \\ ⋮ & ⋱ & ⋮ \\ 0 & … & {e}^{j {θ}_{{N}_{3} - 1}}\end{matrix} ] ;$$

θ₀, . . . , θ_{N}_{₃}₋₁, are phase adjustment coefficients for N₃ subbands.
45. The method of item 44, wherein the second codebook further comprises θ₀, . . . , θ_{N}_{₃}₋₁ from 4 or 8 or 16 PSK symbol set.
46. The method of item 44, wherein each value of θ₀, . . . , θ_{N}_{₃}₋₁ is determined independently for each layer.
47. The method of item 37, wherein the second codebook is generated with phase adjustment coefficients for linear combination coefficients.
48. The method of item 47, wherein the PMI is determined based on

$$P = {W}_{1} {\tilde{W}}_{2} {W}_{f}^{H} where {\tilde{W}}_{2} = [ \begin{matrix}{e}^{j {θ}_{0 , 0}} {\tilde{c}}_{0 , 0} & … & {e}^{j {θ}_{0 , {M}_{v} - 1}} {\tilde{c}}_{0 , {M}_{v} - 1} \\ ⋮ & ⋱ & ⋮ \\ {e}^{j {θ}_{2 L - 1 , 0}} {\tilde{c}}_{2 L - 1 , 0} & … & {e}^{j {θ}_{2 L - 1 , {M}_{v} - 1}} {\tilde{c}}_{2 L - 1 , {M}_{v} - 1}\end{matrix} ] ;$$

\tilde{c}_{0,0}, . . . , \tilde{c}_{0,M}_{ᵥ}₋₁, . . . , \tilde{c}_{2L-1,M}_{ᵥ}₋₁ are the linear combination coefficients in W₂; and θ_{0,0}, . . . , θ_{0,M}_{ᵥ}₋₁, . . . , θ_{2L-1,M}_{ᵥ}₋₁ are phase adjustment coefficients for the linear combination coefficients.
49. The method of item 48, wherein the second codebook further comprises θ_{0,0}, . . . , θ_{0,M}_{ᵥ}₋₁, . . . , θ_{2L-1,M}_{ᵥ}₋₁ from 4, 8, or 16 PSK symbol set.
50. The method of item 48, wherein location of non-zero elements of θ_{0,0}, . . . , θ_{0,M}_{ᵥ}₋₁, . . . , θ_{2L-1,M}_{ᵥ}₋₁ in W₂ is indicated by a bitmap, and the bitmap is the same as that for non-zero linear combination coefficients of \tilde{c}_{0,0}, . . . , \tilde{c}_{0,M}_{ᵥ}₋₁, . . . , \tilde{c}_{2L-1,M}_{ᵥ}₋₁.
51. The method of item 48, wherein each value of the non-zero elements of θ_{0,0}, . . . , θ_{0,M}_{ᵥ}₋₁, . . . , θ_{2L-1,M}_{ᵥ}₋₁ is determined independently for each layer.
52. The method of item 48, wherein the second codebook comprises merged combination coefficients based on merge between non-zero elements of θ_{0,0}, . . . , θ_{0,M}_{ᵥ}₋₁, . . . , θ_{2L-1,M}_{ᵥ}₋₁ and phase of non-zero linear combination coefficients of \tilde{c}_{0,0}, . . . , \tilde{c}_{0,M}_{ᵥ}₋₁, . . . , \tilde{c}_{2L-1,M}_{ᵥ}₋₁.
53. The method of item 52, wherein the second codebook further comprises feedback bits indicating the strongest merged combination coefficients of each layer.
54. The method of item 37, wherein the first codebook and the second codebook are configured with common configuration parameters of:
CSI-RS port number and corresponding N₁ and N₂,
selected beam number L,
frequency compression ratio pᵥ, and subband PMI number per subband Channel Quality Indicator (CQI).

In a yet further aspect, some items as examples of the disclosure concerning a method of gNB may be summarized as follows:
55. A method, comprising:
transmitting, by a transmitter, a configuration signalling for a first codebook and a second codebook, wherein the first codebook is for Channel State Information (CSI) reporting to a first transmitting-receiving entity, and the second codebook is for CSI reporting to a second transmitting-receiving entity;
receiving, by a receiver, a Precoder Matrix Indicator (PMI), wherein the PMI is determined based on the second codebook comprising one or more phase adjustment coefficients.
56. The method of item 55, wherein the second codebook is generated with phase adjustment coefficients for selected beams or beamformed CSI-RS ports.
57. The method of item 56, wherein the PMI is determined based on

$$P = {\tilde{W}}_{1} {W}_{2} {W}_{f}^{H} , where$$

$${\tilde{W}}_{1} = [ \begin{matrix}{e}^{j {θ}_{0 , 0}} {v}_{0} & {e}^{j {θ}_{1 , 0}} {v}_{1} … {e}^{j {θ}_{L - 1 , 0}} {v}_{L - 1} & & 0 \\ & 0 & {e}^{j {θ}_{0 , 1}} {v}_{0} & {e}^{j {θ}_{1 , 1}} {v}_{1} … {e}^{j {θ}_{L - 1 , 1}} {v}_{L - 1}\end{matrix} ] ;$$

$${\{ {v}_{i} \}}_{i = 0}^{L - 1}$$

denotes the selected beams or selected beamformed CSI-RS ports; and θ_{0,0}, . . . , θ_{L-1,0}, . . . , θ_{0,1}, . . . , θ_{L-1,1} are phase adjustment coefficients for the selected beams or selected beamformed CSI-RS ports.
58. The method of item 57, wherein the second codebook further comprises θ_{0,0}, . . . , θ_{L-1,0}, . . . , θ_{0,1}, . . . , θ_{L-1,1} from 4 or 8 or 16 Phase-Shift Keying (PSK) symbol set.
59. The method of item 57, wherein each value of θ_{0,0}, . . . , θ_{L-1,0}, . . . , θ_{0,1}, . . . , θ_{L-1,1} is determined independently for each layer.
60. The method of item 57 or 59, wherein each value of θ_{0,0}, . . . , θ_{L-1,0} and its corresponding value of θ_{0,1}, . . . , θ_{L-1,1} are determined to have a same value.
61. The method of item 55, wherein the second codebook is generated with phase adjustment coefficients for each subband.
62. The method of item 61, wherein the PMI is determined based on

$$P = {W}_{1} {{W}_{2} ( {W}_{3} {W}_{f} )}^{H} , where {W}_{3} = [ \begin{matrix}{e}^{j {θ}_{0}} & … & 0 \\ ⋮ & ⋱ & ⋮ \\ 0 & … & {e}^{j {θ}_{{N}_{3} - 1}}\end{matrix} ] ;$$

θ₀, . . . , θ_{N}_{₃}₋₁, are phase adjustment coefficients for N₃ subbands.
63. The method of item 62, wherein the second codebook further comprises θ₀, . . . , θ_{N}_{₃}₋₁ from 4 or 8 or 16 PSK symbol set.
64. The method of item 62, wherein each value of θ₀, . . . , θ_{N}_{₃}₋₁ is determined independently for each layer.
65. The method of item 55, wherein the second codebook is generated with phase adjustment coefficients for linear combination coefficients.
66. The method of item 65, wherein the PMI is determined based on

$$P = {W}_{1} {\tilde{W}}_{2} {W}_{f}^{H} where {\tilde{W}}_{2} = [ \begin{matrix}{e}^{j {θ}_{0 , 0}} {\tilde{c}}_{0 , 0} & … & {e}^{j {θ}_{0 , {M}_{v} - 1}} {\tilde{c}}_{0 , {M}_{v} - 1} \\ ⋮ & ⋱ & ⋮ \\ {e}^{j {θ}_{2 L - 1 , 0}} {\tilde{c}}_{2 L - 1 , 0} & … & {e}^{j {θ}_{2 L - 1 , {M}_{v} - 1}} {\tilde{c}}_{2 L - 1 , {M}_{v} - 1}\end{matrix} ] ;$$

\tilde{c}_{0,0}, . . . , \tilde{c}_{0,M}_{ᵥ}₋₁, . . . , \tilde{c}_{2L-1,M}_{ᵥ}₋₁ are the linear combination coefficients in W₂; and θ_{0,0}, . . . , θ_{0,M}_{ᵥ}₋₁, . . . , θ_{2L-1,M}_{ᵥ}₋₁ are phase adjustment coefficients for the linear combination coefficients.
67. The method of item 66, wherein the second codebook further comprises θ_{0,0}, . . . , θ_{0,M}_{ᵥ}₋₁, . . . , θ_{2L-1,M}_{ᵥ}₋₁ from 4, 8, or 16 PSK symbol set.
68. The method of item 66, wherein location of non-zero elements of θ_{0,0}, . . . , θ_{0,M}_{ᵥ}₋₁, . . . , θ_{2L-1,M}_{ᵥ}₋₁ in \tilde{W}₂ is indicated by a bitmap, and the bitmap is the same as that for non-zero linear combination coefficients of \tilde{c}_{0,0}, . . . , \tilde{c}_{0,M}_{ᵥ}₋₁, . . . , \tilde{c}_{2L-1,M}_{ᵥ}₋₁.
69. The method of item 66, wherein each value of the non-zero elements of θ_{0,0}, . . . , θ_{0,M}_{ᵥ}₋₁, . . . , θ_{2L-1,M}_{ᵥ}₋₁ is determined independently for each layer.
70. The method of item 66, wherein the second codebook comprises merged combination coefficients based on merge between non-zero elements of θ_{0,0}, . . . , θ_{0,M}_{ᵥ}₋₁, . . . , θ_{2L-1,M}_{ᵥ}₋₁ and phase of non-zero linear combination coefficients of \tilde{c}_{0,0}, . . . , \tilde{c}_{0,M}_{ᵥ}₋₁, . . . , \tilde{c}_{2L-1,M}_{ᵥ}₋₁.
71. The method of item 70, wherein the second codebook further comprises feedback bits indicating the strongest merged combination coefficients of each layer.
72. The method of item 55, wherein the first codebook and the second codebook are configured with common configuration parameters of:
CSI-RS port number and corresponding N₁ and N₂,
selected beam number L,
frequency compression ratio pᵥ, and
subband PMI number per subband Channel Quality Indicator (CQI).

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1. An apparatus for wireless communication, comprising:
at least one memory; and
at least one processor coupled with the at least one memory and configured to cause the apparatus to:
receive a configuration signaling for a first codebook and a second codebook, wherein the first codebook is for Channel State Information (CSI) reporting to a first transmitting-receiving entity, and the second codebook is for CSI reporting to a second transmitting-receiving entity;
determine a Precoder Matrix Indicator (PMI) based on the second codebook comprising one or more phase adjustment coefficients; and
transmit the PMI in reporting of CSI.

2. The apparatus of claim 1, wherein the second codebook is generated with phase adjustment coefficients for selected beams or beamformed channel state information reference signal (CSI-RS) ports.

3. The apparatus of claim 2, wherein the PMI is determined based on
$$P = {\tilde{W}}_{1} {W}_{2} {W}_{f}^{H} , where$$
$${\tilde{W}}_{1} = [ \begin{matrix}{e}^{j {θ}_{0 , 0}} {v}_{0} & {e}^{j {θ}_{1 , 0}} {v}_{1} … {e}^{j {θ}_{L - 1 , 0}} {v}_{L - 1} & & 0 \\ & 0 & {e}^{j {θ}_{0 , 1}} {v}_{0} & {e}^{j {θ}_{1 , 1}} {v}_{1} … {e}^{j {θ}_{L - 1 , 1}} {v}_{L - 1}\end{matrix} ] ;$$
$${\{ {v}_{i} \}}_{i = 0}^{L - 1}$$
denotes the selected beams or selected beamformed CSI-RS ports; and
θ_{0,0}, . . . , θ_{L-1,0}, . . . , θ_{0,1}, . . . , θ_{L-1,1} are phase adjustment coefficients for the selected beams or selected beamformed CSI-RS ports.

4. The apparatus of claim 1, wherein the second codebook is generated with phase adjustment coefficients for each subband.

5. The apparatus of claim 4, wherein the PMI is determined based on
$$P = {W}_{1} {{W}_{2} ( {W}_{3} {W}_{f} )}^{H} , where {W}_{3} = [ \begin{matrix}{e}^{j {θ}_{0}} & … & 0 \\ ⋮ & ⋱ & ⋮ \\ 0 & … & {e}^{j {θ}_{{N}_{3} - 1}}\end{matrix} ] ;$$
θ₀, . . . , θ_{N}_{₃}₋₁, are phase adjustment coefficients for N₃ subbands.

6. The apparatus of claim 1, wherein the second codebook is generated with phase adjustment coefficients for linear combination coefficients.

7. The apparatus of claim 6, wherein the PMI is determined based on
$$P = {W}_{1} {\tilde{W}}_{2} {W}_{f}^{H} where {\tilde{W}}_{2} = [ \begin{matrix}{e}^{j {θ}_{0 , 0}} {\tilde{c}}_{0 , 0} & … & {e}^{j {θ}_{0 , {M}_{v} - 1}} {\tilde{c}}_{0 , {M}_{v} - 1} \\ ⋮ & ⋱ & ⋮ \\ {e}^{j {θ}_{2 L - 1 , 0}} {\tilde{c}}_{2 L - 1 , 0} & … & {e}^{j {θ}_{2 L - 1 , {M}_{v} - 1}} {\tilde{c}}_{2 L - 1 , {M}_{v} - 1}\end{matrix} ] ;$$
\tilde{c}_{0,0}, . . . , \tilde{c}_{0,M}_{ᵥ}₋₁, . . . , \tilde{c}_{2L-1,M}_{ᵥ}₋₁ are the linear combination coefficients in W₂; and
θ_{0,0}, . . . , θ_{0,M}_{ᵥ}₋₁, . . . , θ_{2L-1,M}_{ᵥ}₋₁ are phase adjustment coefficients for the linear combination coefficients.

8. The apparatus of claim 7, wherein location of non-zero elements of θ_{0,0}, . . . , θ_{0,M}_{ᵥ}₋₁, . . . , θ_{2L-1,M}_{ᵥ}₋₁ in \tilde{W}₂ is indicated by a bitmap, and the bitmap is the same as that for non-zero linear combination coefficients of \tilde{c}_{0,0}, . . . , \tilde{c}_{0,M}_{ᵥ}₋₁, . . . , \tilde{c}_{2L-1,M}_{ᵥ}₋₁.

9. The apparatus of claim 3, wherein the second codebook further comprises:
θ_{0,0}, . . . , θ_{L-1,0}, . . . , θ_{0,1}, . . . , θ_{L-1,1} from 4, 8, or 16 Phase-Shift Keying (PSK) symbol set;
θ₀, . . . , θ_{N}_{₃}₋₁ from 4, 8, or 16 PSK symbol set; or
θ_{0,0}, . . . , θ_{0,M}_{ᵥ}₋₁, . . . , θ_{2L-1,M}_{ᵥ}₋₁ from 4, 8, or 16 PSK symbol set.

10. The apparatus of claim 3, wherein
each value of θ_{0,0}, . . . , θ_{L-1,0}, . . . , θ_{0,1}, . . . , θ_{L-1,1} is determined independently for each layer;
each value of θ₀, . . . , θ_{N}_{₃}₋₁ is determined independently for each layer; or
each value of the non-zero elements of θ_{0,0}, . . . , θ_{0,M}_{ᵥ}₋₁, . . . , θ_{2L-1,M}_{ᵥ}₋₁ is determined independently for each layer.

11. The apparatus of claim 3, wherein each value of θ_{0,0}, . . . , θ_{L-1,0} and its corresponding value of θ_{0,1}, . . . , θ_{L-1,1} are determined to have a same value.

12. The apparatus of claim 1, wherein the second codebook comprises merged combination coefficients based on a merge between non-zero elements of θ_{0,0}, . . . , θ_{0,M}_{ᵥ}₋₁, . . . , θ_{2L-1,M}_{ᵥ}₋₁ and phase of non-zero linear combination coefficients of \tilde{c}_{0,0}, . . . , \tilde{c}_{0,M}_{ᵥ}₋₁, . . . , \tilde{c}_{2L-1,M}_{ᵥ}₋₁; and the second codebook further comprises feedback bits indicating a strongest merged combination coefficients of each layer.

13. The apparatus of claim 1, wherein the first codebook and the second codebook are configured with one or more common configuration parameters, including:
channel state information reference signal (CSI-RS) port number and corresponding N₁ and N₂,
selected beam number L,
frequency compression ratio pᵥ, or
subband PMI number per subband Channel Quality Indicator (CQI).

14. An apparatus for wireless communication, comprising:
at least one memory; and
at least one processor coupled with the at least one memory and configured to cause the apparatus to:
transmit a configuration signalling for a first codebook and a second codebook, wherein the first codebook is for Channel State Information (CSI) reporting to a first transmitting-receiving entity, and the second codebook is for CSI reporting to a second transmitting-receiving entity;
receive a Precoder Matrix Indicator (PMI), wherein the PMI is determined based on the second codebook comprising one or more phase adjustment coefficients.

15. A method performed by an apparatus, the method comprising:
receiving a configuration signaling for a first codebook and a second codebook, wherein the first codebook is for Channel State Information (CSI) reporting to a first transmitting-receiving entity, and the second codebook is for CSI reporting to a second transmitting-receiving entity;
determining a Precoder Matrix Indicator (PMI) based on the second codebook comprising one or more phase adjustment coefficients; and
transmitting the PMI in reporting of CSI.

16. A processor for wireless communication, comprising:
at least one controller coupled with at least one memory and configured to cause the processor to:
receive a configuration for a first codebook and a second codebook,
wherein the first codebook is for Channel State Information (CSI) reporting to a first transmitting-receiving entity, and the second codebook is for CSI reporting to a second transmitting-receiving entity;
determine a Precoder Matrix Indicator (PMI) based on the second codebook comprising one or more phase adjustment coefficients; and
transmit the PMI in reporting of CSI.

17. The processor of claim 15, wherein the second codebook is generated with phase adjustment coefficients for each subband.

18. The processor of claim 16, wherein the PMI is determined based
$$P = {W}_{1} {{W}_{2} ( {W}_{3} {W}_{f} )}^{H} , where {W}_{3} = [ \begin{matrix}{e}^{j {θ}_{0}} & … & 0 \\ ⋮ & ⋱ & ⋮ \\ 0 & … & {e}^{j {θ}_{{N}_{3} - 1}}\end{matrix} ] ;$$
θ₀, . . . , θ_{N}_{₃}₋₁, are phase adjustment coefficients for N₃ subbands.

19. The processor of claim 16, wherein the first codebook and the second codebook are configured with one or more common configuration parameters, including:
channel state information reference signal (CSI-RS) port number and corresponding N₁ and N₂,
selected beam number L,
frequency compression ratio pᵥ, or
subband PMI number per subband Channel Quality Indicator (CQI).

20. The processor of claim 16, wherein the first codebook and the second codebook are configured common configuration parameters, including:
channel state information reference signal (CSI-RS) port number and corresponding N₁ and N₂,
frequency compression ratio pᵥ, and
subband PMI number per subband Channel Quality Indicator (CQI).
